(19) United States
(12) Patent Application Publication
(10) Pub. No.: US 2015/0023013 A1
(43) Pub. Date: Jan. 22, 2015

(54) Illuminating Unit

(71) Applicant: Yazaki Corporation, Minato-ku, Tokyo (JP)

(72) Inventor: Shinji Mochizuki, Makinohara-shi (JP)

(73) Assignee: Yazaki Corporation, Minato-ku, Tokyo (JP)

(21) Appl. No.: 14/376,213

(22) PCT Filed: Feb. 14, 2013
(86) PCT No.: PCT/JP2013/054243

§ 371 Date: Aug. 1, 2014

(30) Foreign Application Priority Data
Feb. 22, 2012 (JP) 2012-036704

(51) Int. Cl. F21V 23/06; F21V 5/04; F21K 99/00

(52) U.S. Cl. CPC F21V 23/06; F21K 9/58; F21V 5/04; F21Y 2101/02
USPC 362/231

(57) ABSTRACT

An illuminating unit includes a first bus bar, a second bus bar and a third bus bar of the same shape, each of which has a pair of right and left contact spring pieces that are spaced in a given direction and parallel to each other. The first bus bar, the second bus bar and the third bus bar are inserted into a housing and aligned in parallel in the given direction. Semiconductor light emitting elements, which emit lights in different color temperatures, are inserted into the housing, and connected to respective adjacent pairs of the right and left contact spring pieces of the first bus bar and the second bus bar, and the second bus bar and the third bus bar. A cover accommodates the housing, and includes a lens through which outgoing lights from the semiconductor light emitting elements pass.

### TECHNICAL FIELD

The present invention relates to a structure of an illuminating unit which controls light intensity of a plurality of LEDs to change color temperature.

### BACKGROUND ART

The structure of an illuminating unit is disclosed in Patent Literature 1 which obtains high reliability by electrically connecting electronic components surely. As shown in FIG. 14, in the structure of the illuminating unit, a pair of bus bars 501 and 503 and a semiconductor light emitting element (LED) 505 which is a source of light are assembled in a housing. The bus bars 501 and 503, which have a planar shape and are divided into two parts, have an electric wire connecting part 507, a Zener diode connecting part 509, a resistor connecting part 511 and an LED connecting part 513. The resistor connecting part 511 includes pressing blades 515 and 515 which are respectively possessed by the divided bus bars 501 and 503. The Zener diode connecting part 509 includes a single pressing blade 517 of the bus bar 501, and a single pressing blade 519 of the other bus bar 503.

When one lead part 523 and the other lead part 525 of the Zener diode 521 are electrically connected to the bus bar 501 and the other bus bar 503, respectively, the Zener diode 521 and a resistor 527 are connected to the pair of bus bars 501 and 503 in parallel at the downstream side of the resistor 527. The Zener diode 521 functions to protect the LED from damage caused due to a sudden large voltage applied to the circuit by static electricity in the direction that a forward current flows through the diode, and also functions to protect the LED from damage by inhibiting a backward current from flowing through the diode.

### CITATION LIST

### Patent Literature

Patent Literature 1: JP-A-2007-149762

### SUMMARY OF INVENTION

### Technical Problem

However, it is necessary for the structure of the traditional illuminating unit to have the two kinds of bus bars 501 and 503 in which the connecting parts (the pressing blades 515 and 515, the pressing blades 517, and the pressing blades 519) of different dimensions are formed in accordance with the shapes and sizes of electronic components. Further, there is a problem that only electronic components (the Zener diode 521, the resistor 527) for through holes that have lead parts can be mounted, but surface-mounted electronic components, which are inexpensive and widely desired in recent years, cannot be connected.

Furthermore, if the traditional illuminating unit is constructed by providing side by side and assembling LEDs of different light color temperatures to make it possible to change color temperature, the unit is upsized. Further, even if the color temperature is changed by controlling light intensity respectively while turning on the LEDs that are provided side by side at the same time, because the distance between LEDs is large, there is a problem that light irregularity occurs.

The present invention is made in view of the above-mentioned situations, and an object of the present invention is provide an illuminating unit so that surface-mounted electronic components can be connected with one kind of bus bars, color temperature can be changed without upsizing the unit, and light irregularity is hard to occur.

### Solution to Problem

Aspects of the present invention are shown with the following configurations.

(1) An illuminating unit, including: a housing; a first bus bar, a second bus bar and a third bus bar of the same shape, each of which has a pair of right and left contact spring pieces that are spaced in a given direction and parallel to each other, wherein the first bus bar, the second bus bar and the third bus bar are inserted into the housing and aligned in parallel in the given direction; a first semiconductor light emitting element which is inserted into the housing, and connected to an adjacent pair of the right and left contact spring pieces of the first bus bar and the second bus bar; a second semiconductor light emitting element which is inserted into the housing, and connected to an adjacent pair of the right and left contact spring pieces of the second bus bar and the third bus bar, wherein the second semiconductor light emitting elements emits light in a color temperature different from that of the first semiconductor light emitting element; and a cover which accommodates the housing, and includes a lens through which outgoing lights from the first semiconductor light emitting element and the second semiconductor light emitting element pass.

According to the illuminating unit in the configuration above (1), the three bus bars or the first bus bar, the second bus bar and the third bus bar are accommodated in the housing closely and in parallel. The first semiconductor light emitting element and the second semiconductor light emitting element, which are different in light color temperature, are assembled into a space between the first bus bar and the second bus bar and a space between the second bus bar and the third bus bar by being connected to the right and left contact spring pieces of the bus bars, respectively. When the light intensity of the first semiconductor light emitting element and the second semiconductor light emitting element are controlled, the color temperature of the outgoing light that passes through the lens is changed. In this case, because the bus bars are closely aligned to each other, while the unit is not upsized, the two or the first semiconductor light emitting element and the second semiconductor light emitting element are arranged closely and in parallel. Thus, because the outgoing lights become easy to be mixed, light irregularity is hard to occur.

(2) The illuminating unit according to the configuration above (1), wherein each of the first bus bar, the second bus bar and the third bus bar has a pair of element abutting seats that are opposite to the respective right and left contact spring pieces, and the first semiconductor light emitting element and the second semiconductor light emitting element have light emitting part defining surfaces, where light emitting parts are provided, which abut against the element abutting seats, to arrange the light emitting parts on a same plane.

According to the illuminating unit of the configuration above (2), the light emitting part defining surfaces, where the light emitting parts of the first semiconductor light emitting element and the second semiconductor light emitting element are provided, are arranged by abutting against the element abutting seats of the first bus bar, the second bus bar and the third bus bar. The first bus bar, the second bus bar and the third bus bar are arranged in the housing together and aligned in parallel, and the element abutting seats, which are opposite to the right and left contact spring pieces, are arranged on the same plane. The light emitting parts of the first semiconductor light emitting element and the second semiconductor light emitting element, which are clamped in the thickness direction by the right and left contact spring pieces and the element abutting seats, are arranged highly precisely on the same plane since the light emitting part defining surfaces abut against the element abutting seats. Thereby, the first semiconductor light emitting element and the second semiconductor light emitting element are highly precisely positioned right-left symmetrically across a central axis of the lens, and light irregularity becomes harder to occur.

(3) The illuminating unit according to the configuration (1), further including a control circuit that controls a light intensity of at least one of the first semiconductor light emitting element and the second semiconductor light emitting element to vary a color temperature of outgoing lights emitted through the lens.

According to the illuminating unit of the configuration above (3), when the control circuit controls the light intensity of the first semiconductor light emitting element and the second semiconductor light emitting element, the color temperature of the outgoing light that passes through the lens is changed. If the light intensity of the first semiconductor light emitting element and the second semiconductor light emitting element is controlled in a stepwise manner, it is possible to emit outgoing light having various color temperature through the lens.

### Advantageous Effects of Invention

According to the illuminating unit in any aspect of the present invention, surface-mounted electronic components can be connected with one kind of bus bars, color temperature can be changed without upsizing the unit, and light irregularity is hard to occur.

The present invention has been clearly disclosed above. Further, the present invention will become more apparent and understandable from the description of the following embodiments of the invention (hereinafter referred to as “embodiments”).

### BRIEF DESCRIPTION OF DRAWINGS

FIG. 1 is a perspective view of an illuminating unit according to an embodiment of the present invention.

FIG. 2 is an exploded perspective view in which a wire holder is separated from the illuminating unit shown in FIG. 1.

FIG. 3 is an exploded perspective view in which a housing is separated from a lens cover shown in FIG. 2.

FIG. 4 is a perspective view which shows a first semiconductor light emitting element, a second semiconductor light emitting element and bus bars, which are accommodated in the housing of FIG. 3, together with electric wires.

FIG. 5 is an enlarged perspective view of the bus bar shown in FIG. 4.

FIG. 6 is a perspective view in which the first semiconductor light emitting element is seen from the side of a surface opposite to a light emitting part defining surface.

FIG. 7 is a sectional view taken along a line indicated by VII-VII arrows of FIG. 1.

FIG. 8 is a perspective view which indicates a bus bar assembling step for the structure of the illuminating unit according to the embodiment of the present invention.

FIG. 9 is a perspective view which indicates a step of assembling the first semiconductor light emitting element and a second semiconductor light emitting element.

FIG. 10 is a perspective view which indicates a step of assembling resistors.

FIG. 11 is a top view which indicates a step of cutting joining parts.

FIG. 12 is a top view of the bus bars in the housing in which the joining parts of the first bus bar and the third bus bar are cut.

FIG. 13 is a circuit diagram of the first semiconductor light emitting element, the second semiconductor light emitting element and the resistors.

FIG. 14 is a perspective view of a traditional illuminating unit.

### DESCRIPTION OF EMBODIMENTS

Below, an embodiment of the invention is described with reference to the figures.

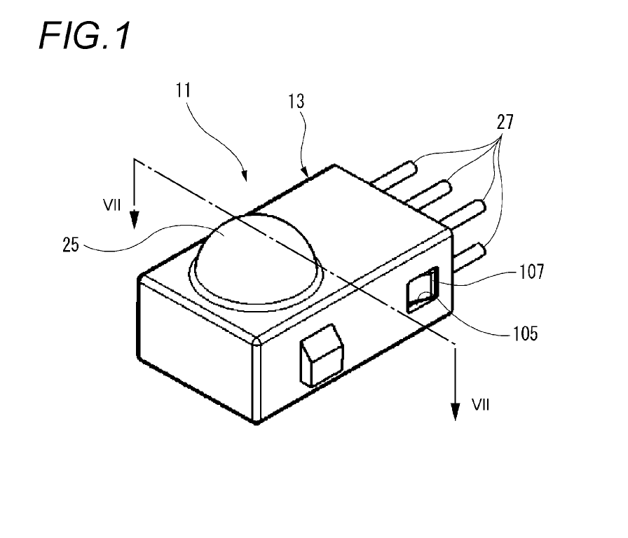

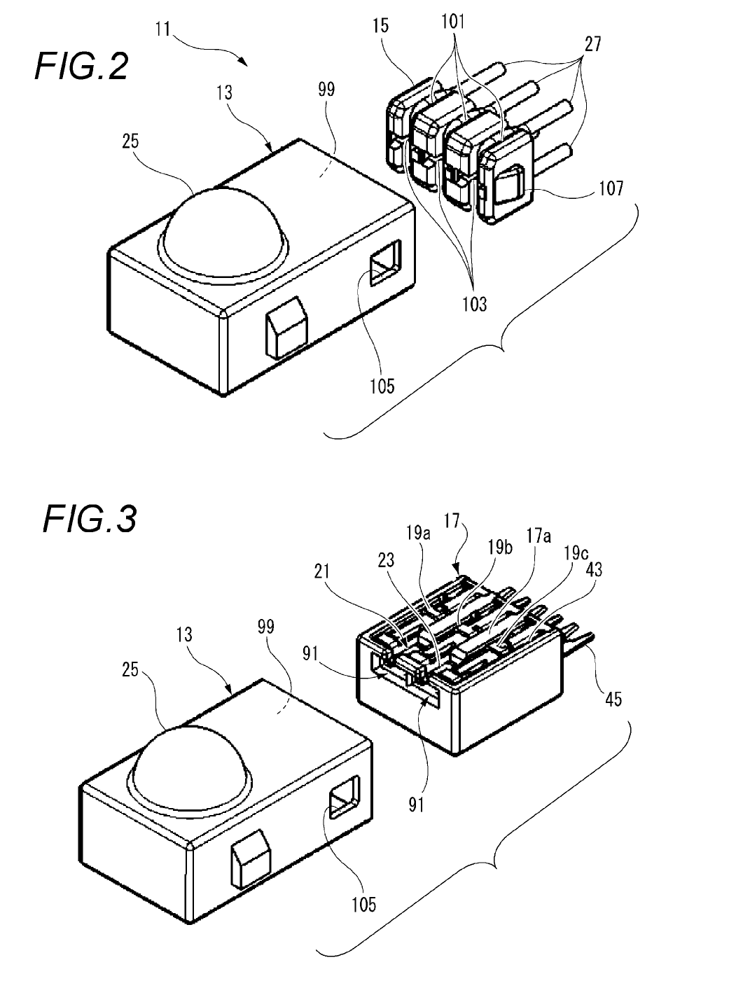

FIG. 1 is a perspective view of an illuminating unit according to an embodiment of the present invention, FIG. 2 is an exploded perspective view in which a wire holder is separated from the illuminating unit shown in FIG. 1, and FIG. 3 is an exploded perspective view in which a housing is separated from a lens cover shown in FIG. 2.

In the structure of an illuminating unit according to the present embodiment, an outer shell becomes a lens cover (cover) 13, and a wire holder 15 shown in FIG. 2 is inserted into the lens cover 13. A box-shaped housing 17 shown in FIG. 3 is inserted into the lens cover 13 to be farther inwards than the wire holder 15. Three bus bars 19a, 19b and 19c, and a first semiconductor light emitting element 21 and a second semiconductor light emitting element 23, which are electronic components, are inserted into the housing 17. The lens cover 13, into which the housing 17 is inserted includes a lens 25 through which outgoing lights from the first semiconductor light emitting element 21 and the second semiconductor light emitting element 23 pass.

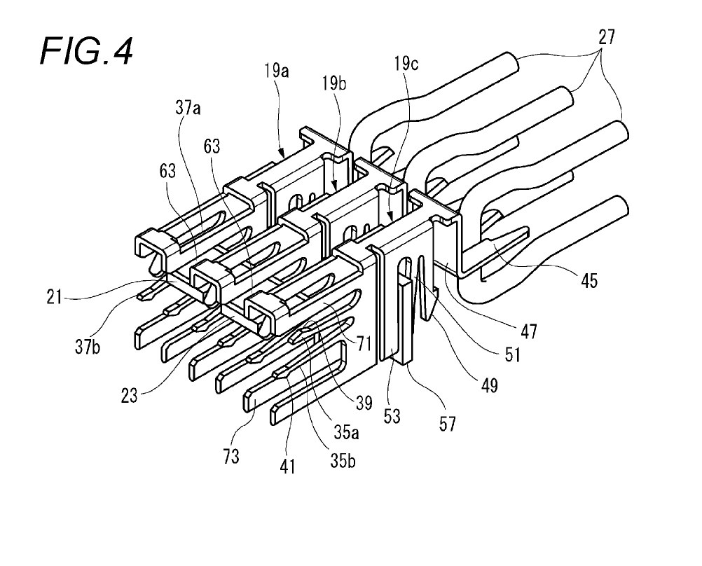

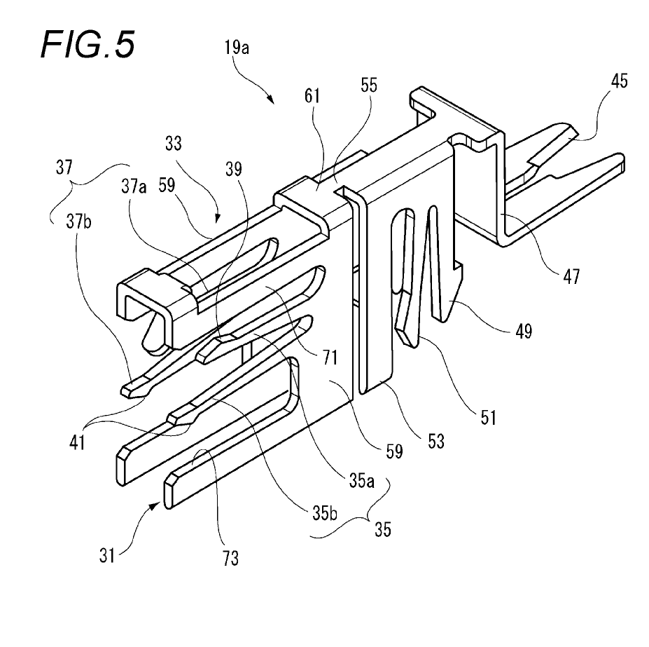

FIG. 4 is a perspective view which shows the first semiconductor light emitting element 21, the second semiconductor light emitting element 23 and the first to the third bus bars 19a, 19b and 19c, which are accommodated in the housing 17 of FIG. 3, together with electric wires 27. FIG. 5 is an enlarged perspective view of the bus bar 19 shown in FIG. 4.

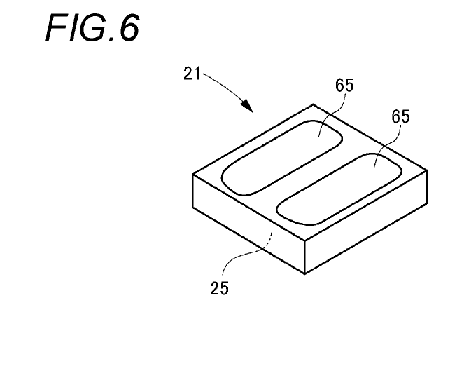

The three or the first to the third bus bars 19a, 19b and 19c of the same shape shown in FIG. 4 are inserted into the housing 17. At one end 31 of each of the first to the third bus bars 19a, 19b and 19c, a terminal part 33 which has two sections, namely, top and bottom sections, is formed. Two pairs of right and left contact spring pieces 35a and 37a, and 35b and 37b, which are spaced and in parallel to each other, are formed at the terminal part 33 of the present embodiment by being arranged into the two or the top and bottom sections. In this embodiment, each of the first to the third bus bars 19a, 19b and 19c is provided with the two pairs of right and left contact spring pieces 35a and 37a, and 35b and 37b by branching the distal ends of a pair of contact spring pieces 35 and 37 into a rough Y shape. Electrical contact parts 39 of two adjacent pairs of right and left contact spring pieces 37a and 35a among the six right and left contact spring piece 35a and 37a at the top sections of the first to the third bus bars 19a, 19b and 19c that are arranged and aligned in parallel are connected to pairs of contact parts 65 of the first semiconductor light emitting element 21 and the second semiconductor light emitting element 23 which are arranged among the three or the first to the third bus bars 19a, 19b and 19c (refer to FIG. 6). The six right and left contact spring pieces 35b and 37b at the bottom sections of the first to the third bus bars 19a, 19b and 19c that are arranged in parallel are not used, and may be omitted in the present embodiment. The electrical contact parts 39 formed at the distal ends of the right and left contact spring pieces 35a and 37a are formed into a triangular shape whose vertex becomes the contact side.

When the three or the first to the third bus bars 19a, 19b and 19c are inserted from a bus bar insertion opening 43 of a housing top surface 17a shown in FIG. 3, respectively, as shown in FIG. 4, the first to the third bus bars 19a, 19b and 19c are lined up to be parallel in the spacing direction described above (arranged in parallel). Upper component seats (element abutting seats) 71 which are formed at the first to the third bus bars 19a, 19b and 19c are opposite to the electrical contact parts 39 at six upper places of the six right and left contact spring pieces 35a and 37a at the top sections of the first to the third bus bars 19a, 19b and 19c which are arranged in parallel. Further, lower component seats 73 which are formed at the first to the third bus bars 19a, 19b and 19c are opposite to electrical contact parts 41 at six lower places of the six right and left contact spring pieces 35b and 37b at the bottom sections of the first to the third bus bars 19a, 19b and 19c which are arranged in parallel.

As shown in FIG. 3, parts of the first to the third bus bars 19a, 19b and 19c are protruded from the housing 17 after the first to the third bus bars 19a, 19b and 19c are installed into the housing 17, respectively. In this embodiment, the side to which the first to the third bus bars 19a, 19b and 19c are protruded from the housing 17 is referred to as the “rear” and the opposite side is referred to as the “front”. The rear end of each of the first to the third bus bars 19a, 19b and 19c is provided with pressing blades 45 for cutting the coatings of the coated electric wires 27 shown in FIG. 2, and electrically contacting conductors. As shown in FIG. 5, a rear abutting piece 47, a rear elastic leg 49, a front elastic leg 51 and front abutting pieces 53 are adjacently provided sequentially in front of the pressing blades 45.

A joining part 55 is formed between a pair of the front abutting pieces 53 and the terminal part 33 of each of the first to the third bus bars 19a, 19b and 19c. The joining parts 55 can be cut after the first to the third bus bars 19a, 19b and 19c are accommodated in the housing 17. The terminal parts 33 of the first to the third bus bars 19a, 19b and 19c, in which the joining parts 55 are cut, are separated from the pressing blades 45. The separated pressing blades 45 and the terminal parts 33 are electrically connected by resistors 57 (refer to FIG. 4) provided between a pair of the front elastic legs 51 and a pair of the front abutting pieces 53.

The pressing blades 45, the rear abutting piece 47, the rear elastic leg 49, the front elastic leg 51, the front abutting piece 53 and the terminal part 33 are integrally punched with sheet metal processing, and then bent into shapes shown in FIG. 5. The terminal part 33 of each of the first to the third bus bars 19a, 19b and 19c is formed by being bent into a U shape so that a pair of side walls 59 become parallel to each other, and the contact spring pieces 35 and 37 are molded by punching the side walls 59 respectively. A bus bar body part 61 of each of the first to the third bus bars 19a, 19b and 19c is formed by bending the terminal part 33 into a U shape, and the right and left contact spring pieces 35a, 37a, 35b and 37b of the contact spring pieces 35 and 37 which are branched into a rough Y shape are formed by punching the pair of opposed side walls 59. Thereby, a large number of the right and left contact spring pieces 35a, 37a, 35b and 37b can be produced easily and compactly.

Next, the first semiconductor light emitting element 21 and the second semiconductor light emitting element 23 are described.

FIG. 6 is a perspective view in which the first semiconductor light emitting element 21 is seen from the side of a surface opposite to a light emitting part defining surface 29.

Because the first semiconductor light emitting element 21 and the second semiconductor light emitting element 23 have the same shape, the first semiconductor light emitting element 21 is illustrated in FIG. 6 as an example. The first semiconductor light emitting element 21 and the second semiconductor light emitting element 23 are surface-mounted semiconductor light emitting elements which are formed into a square board shape. One surface of each of the first semiconductor light emitting element 21 and the second semiconductor light emitting element 23 becomes a light emitting part defining surface 29 where a light emitting part 63 (refer to FIG. 4) is formed. The pair of contact parts 65 are formed at the rear side of the light emitting part defining surface 29. The first semiconductor light emitting element 21 and the second semiconductor light emitting element 23 emit lights with different color temperatures. The first semiconductor light emitting element 21 emits, for example, a light with a bulb color (3000K), and the second semiconductor light emitting element 23 emits, for example, a light with a white color (6000K).

In the structure of the illuminating unit 11 of the present embodiment, the three or the first to the third bus bars 19a, 19b and 19c of the same shape are used. The three or the first to the third bus bars 19a, 19b and 19c of the same shape are lined up as the first bus bar 19a, the second bus bar 19b and the third bus bar 19c sequentially from the left side of FIG. 4. The first semiconductor light emitting element 21 is connected to a pair of adjacent right and left contact spring pieces 35a and 37a of the first bus bar 19a and the second bus bar 19b. The second semiconductor light emitting element 23 is connected to a pair of adjacent right and left contact spring pieces 35a and 37a of the second bus bar 19b and the third bus bar 19c.

The first semiconductor light emitting element 21 and the second semiconductor light emitting element 23 are arranged on the same plane and the light emitting part defining surfaces 29 where the light emitting parts 63 are provided abut against the upper component seats 71.

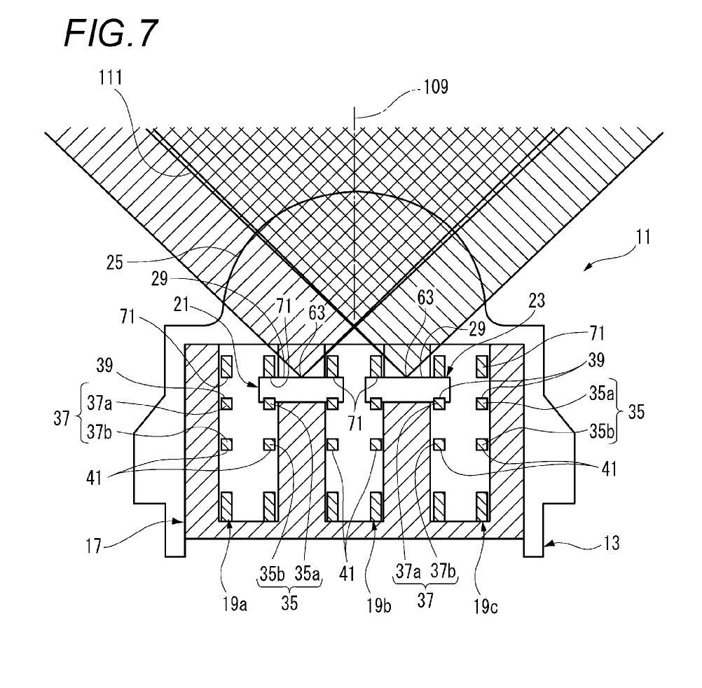

FIG. 7 is a sectional view taken along a line indicated by VII-VII arrows of FIG. 1.

When the first bus bar 19a, the second bus bar 19b and the third bus bar 19c are accommodated in the housing 17, as shown in FIG. 7, the six right and left contact spring pieces 35a, 37a are arranged in one section. The pair of contact parts 65 of the first semiconductor light emitting element 21 are connected to the second and the third electrical contact parts 39 from left of these six right and left contact spring pieces 35a and 37a. The pair of contact parts 65 of the second semiconductor light emitting element 23 are connected to the fourth and the fifth electrical contact parts 39 from left of these six right and left contact spring pieces 35a and 37a. In this embodiment, the first and the sixth electrical contacts 39 from left among the six right and left contact spring pieces 35a and 37a are not used.

Then, steps of assembling the illuminating unit 11 of the above construction are described.

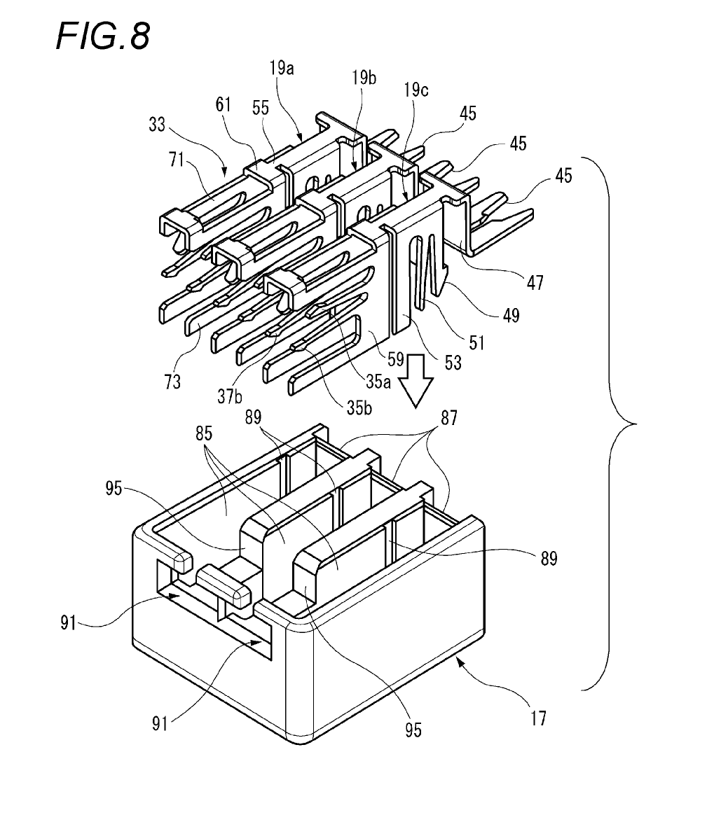

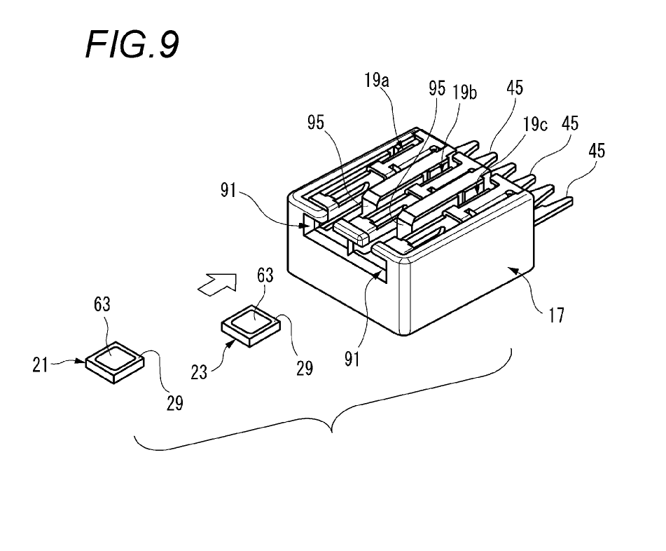

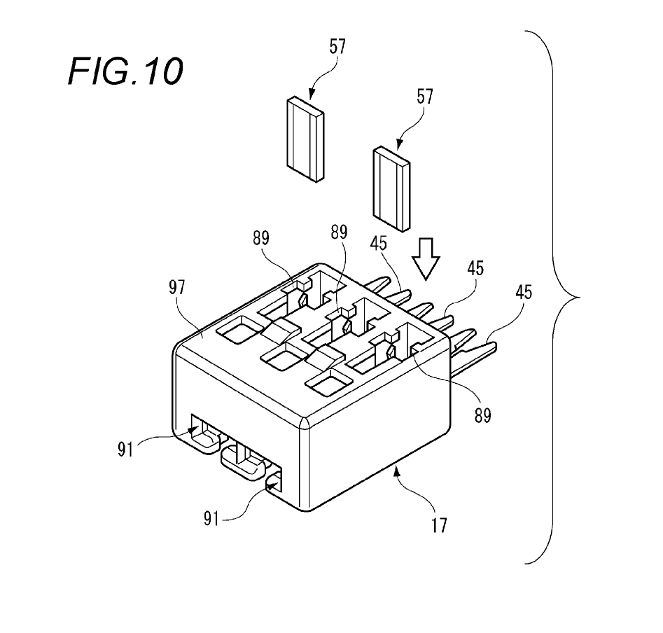

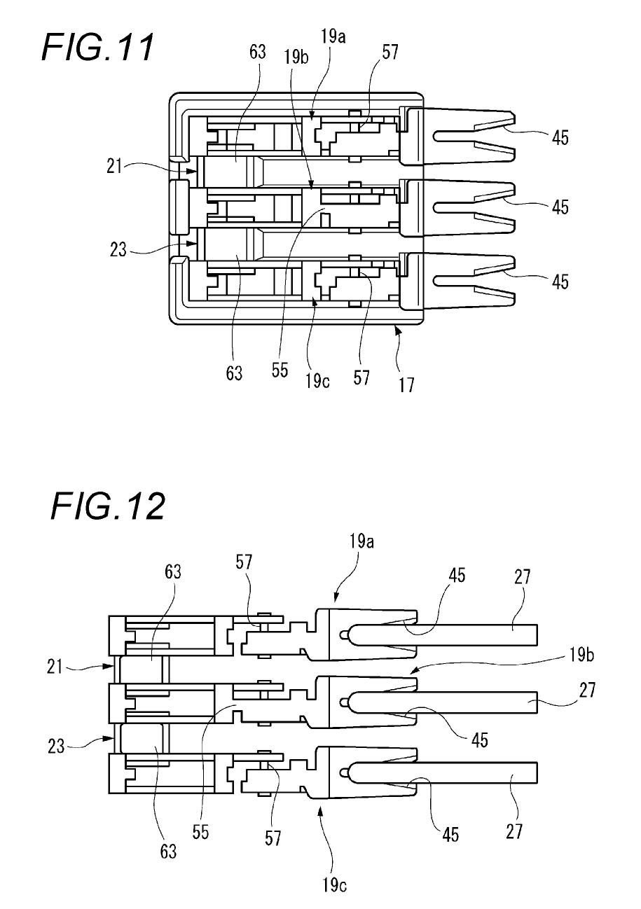

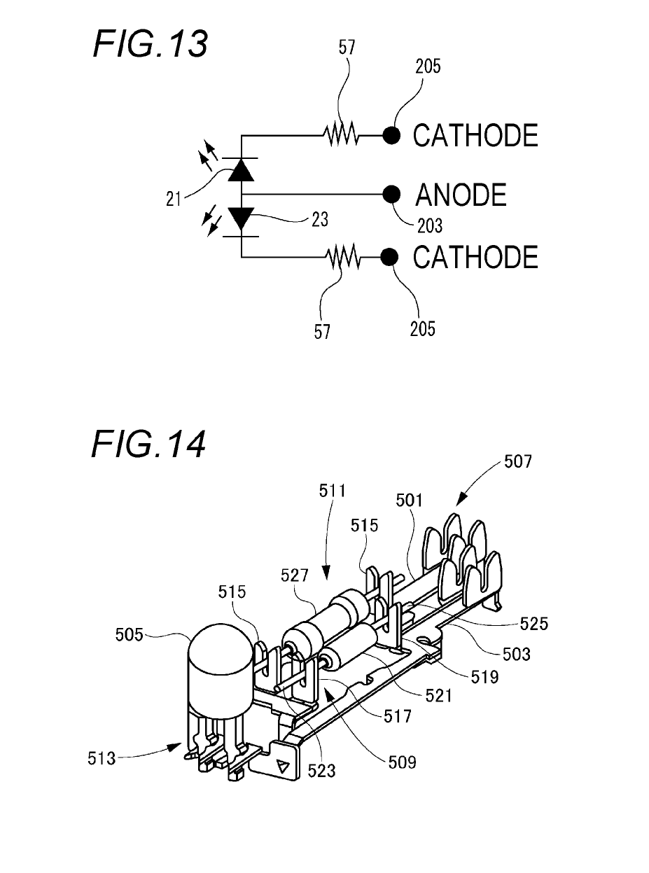

FIG. 8 is a perspective view which indicates a bus bar assembling step for the structure of the illuminating unit 11 according to the embodiment of the present invention. FIG. 9 is a perspective view which indicates a step of assembling the first semiconductor light emitting element 21 and the second semiconductor light emitting element 23. FIG. 10 is a perspective view which indicates a step of assembling the resistors. FIG. 11 is a top view which indicates a step of cutting the joining parts. FIG. 12 is a top view of the first to the third bus bars 19a, 19b and 19c in the housing in which the joining parts 55 of the first bus bar 19a and the third bus bar 19c are cut. FIG. 13 is a circuit diagram of the first semiconductor light emitting element 21, the second semiconductor light emitting element 23 and the resistors 57.

To assemble the illuminating unit 11, as shown in FIG. 8, the three or the first to the third bus bars 19a, 19b and 19c are installed into the housing 17.

Three bus bar receiving rooms 85 are formed in the housing 17. The rear ends of the bus bar receiving rooms 85 become rear walls 87, and a pair of retaining grooves 89 are formed on inner wall surfaces in front of the rear walls 87. When the first to the third bus bars 19a, 19b and 19c are respectively inserted into the bus bar receiving rooms 85, the rear walls 87 are clamped by the rear abutting pieces 47 and the rear elastic legs 49 so that the first to the third bus bars 19a, 19b and 19c are installed by being regulated from falling off from the housing 17.

As shown in FIG. 9, a pair of LED installation openings 91 are formed at the front surface of the housing 17. The first semiconductor light emitting element 21 is inserted into one of the LED installation openings 91, and the second semiconductor light emitting element 23 is inserted into the other of the LED installation openings 91, with the contact parts 65 of the first semiconductor light emitting element 21 and the second semiconductor light emitting element 23 facing downwards. The insertion of the first semiconductor light emitting element 21 and the second semiconductor light emitting element 23 that are inserted into the housing 17 is regulated by stopper surfaces 95 formed in the housing 17 so that the first semiconductor light emitting element 21 and the second semiconductor light emitting element 23 stop at predetermined fixed positions. Thereby, the contact parts 65 of the first semiconductor light emitting element 21 and the second semiconductor light emitting element 23 are respectively connected to the electrical contact parts 39 of the first to the third bus bars 19a, 19b and 19c, as shown in FIG. 7.

It is necessary for the illuminating unit 11 according to the present embodiment to have a circuit which is provided with the resistors 57 respectively between the first semiconductor light emitting element 21 and a cathode, and between the second semiconductor light emitting element 23 and the cathode. As shown in FIG. 10, the resistors 57 are inserted into the retaining grooves 89 which open to the bottom surface 97 of the housing 17. Thereby, the resistors 57 are clamped by the front abutting pieces 53 and the front elastic legs 51 of the first and the third bus bars 19a and 19c, and the front elastic legs 51 are connected to a pair of contact parts (not shown in the figure) of the resistors 57.

As shown in FIG. 11, after the resistors 57 are inserted into the retaining groove 89, the joining parts 55 of the first bus bar 19a and third bus bar 19c are cut. The joining part 55 of the second bus bar 19b that is connected to an anode 203 is left without being cut.

As shown in FIG. 12, the first to the third bus bars 19a, 19b and 19c in which the predetermined joining parts 55 are cut construct a circuit shown in FIG. 13. That is, the anode side contact parts 65 of the first semiconductor light emitting element 21 and the second semiconductor light emitting element 23 are connected to the anode 203 by the second bus bar 19b. Further, the cathode side contact part 65 of the first semiconductor light emitting element 21 is connected to a cathode 205 through the resistor 57 by the first bus bar 19a, and the cathode side contact part 65 of the second semiconductor light emitting element 23 is connected to the cathode 205 through the resistor 57 by the third bus bar 19c.

The first bus bar 19a and the third bus bar 19c connected to the cathode 205 are connected to a PWM control circuit. The PWM control circuit controls the light intensity of at least one of the first semiconductor light emitting element 21 and the second semiconductor light emitting element 23 in a grade modulation manner. For example, the light emission periods of the first semiconductor light emitting element 21 the second semiconductor light emitting element 23 in one cycle are controlled at a predetermined number of grades (for example, 100 grades) in a range of 0-100%. Thereby, outgoing light from the lens 25 of the illuminating unit 11 can be changed in a color temperature between 3000K and 6000K.

The housing 17, in which the first semiconductor light emitting element 21 and the second semiconductor light emitting element 23 are installed, is installed in the lens cover 13 shown in FIG. 3. A housing insertion opening 99 is formed at the rear end surface of the lens cover 13. After the housing 17 is inserted into the lens cover 13, the pressing blades 45 are protruded rearwards inside the lens cover 13.

The wire holder 15 shown in FIG. 2 is inserted into the lens cover 13, in which the housing 17 is installed, from the housing insertion opening 99. U-shaped electric wire retaining grooves 101 are formed at two places on three outer surfaces of the wire holder 15. The coated electric wires 27 are bent into a U shape and installed in the electric wire retaining grooves 101, respectively. Horizontal pressing blade entry slits 103 are formed across the electric wire retaining grooves 101 at the front surface of the wire holder 15. Thereby, when the wire holder 15 is inserted into the lens cover 13, the pressing blades 45 of the first to the third bus bars 19a, 19b and 19c which are protruded rearwards inside the lens cover 13 enter into the pressing blade entry slits 103, so that the pressing blades 45 and the conductors of the electric wires 27 are connected.

After the wire holder 15 is inserted into the lens cover 13, a locking pawl 107 projected from a side surface of the wire holder 15 is locked in a locking hole 105 formed at the side of the lens cover 13 so that the housing 17 and the wire holder itself are regulated from detaching from the lens cover 13. The illuminating unit 11 shown in FIG. 1 is constructed by installing the housing 17 and the wire holder 15 into the lens cover 13.

In the structure of the illuminating unit 11 assembled as above, the three bus bars or the first bus bar 19a, the second bus bar 19b and the third bus bar 19c are accommodated in the housing 17 closely and in parallel. The first semiconductor light emitting element 21 and the second semiconductor light emitting element 23, which are different in light color temperature, are assembled into a space between the first bus bar 19a and the second bus bar 19b and a space between the second bus bar 19b and the third bus bar 19c by being connected to the right and left contact spring pieces 35a and 37a of the bus bars, respectively. When the light intensity of at least one of the first semiconductor light emitting element 21 and the second semiconductor light emitting element 23 is controlled, the color temperature of the outgoing light that passes through the lens 25 is changed. In this case, because the bus bars are close to each other, while the illuminating unit 11 is not upsized, the two or the first semiconductor light emitting element 21 and the second semiconductor light emitting element 23 are arranged closely and in parallel. Thus, because the outgoing lights become easy to be mixed, light irregularity is hard to occur.

In the illuminating unit 11 of the present embodiment, the light emitting part defining surfaces 29, where the light emitting parts 63 of the first semiconductor light emitting element 21 and the second semiconductor light emitting element 23 are provided, are arranged by abutting against the upper component seats 71 of the first bus bar 19a, the second bus bar 19b and the third bus bar 19c. The first bus bar 19a, the second bus bar 19b and the third bus bar 19c are arranged in the housing 17 together and in parallel, and the upper component seats 71, which are opposite to the right and left contact spring pieces 35a and 37a, are arranged on the same plane. The light emitting parts 63 of the first semiconductor light emitting element 21 and the second semiconductor light emitting element 23, which are clamped in the thickness direction by the right and left contact spring pieces 35 and the upper component seats 71, are arranged highly precisely on the same plane since the light emitting part defining surfaces 29 abut against the upper component seats 71. Thereby, the first semiconductor light emitting element 21 and the second semiconductor light emitting element 23 are highly precisely positioned right-left symmetrically across a central axis 109 of the lens 25. Light irregularity in the mixed outgoing light 111 (refer to FIG. 7) becomes harder to occur.

Therefore, according to the structure of the illuminating unit 11 of the present embodiment, the surface-mounted first semiconductor light emitting element 21 and second semiconductor light emitting element 23 can be connected with one kind of bus bars. Besides, color temperature can be changed without upsizing the unit, and light irregularity is hard to occur. The structure of the illuminating unit of the invention is not restricted to the above-described embodiment, but suitable modifications, improvements and the like can be made. Moreover, the materials, shapes, dimensions, numbers, installation places, and the like of the components in the above embodiments are arbitrarily set as far as the invention can be attained, and not particularly restricted.

The present application is based upon and claims the benefit of Japanese patent application No. 2012-036704 filed on Feb. 22, 2012, the contents of which are incorporated by reference in its entirety.

### INDUSTRIAL APPLICABILITY

The present invention is useful because the illuminating unit as mentioned above provides effects that surface-mounted electronic components can be connected with one kind of bus bars, color temperature can be changed without upsizing the unit, and light irregularity is hard to occur.

### REFERENCE SIGNS LIST

11: Illuminating unit

13: Lens cover (cover)

17: Housing

19a: First bus bar

19b: Second bus bar

19c: Third bus bar

21: First semiconductor light emitting element

23: Second semiconductor light emitting element

25: Lens

29: Light emitting part defining surface

35a: Right and left contact spring piece

37a: Right and left contact spring piece

63: Light emitting part

71: Upper component seat (element abutting seat)

1. An illuminating unit, comprising:
a housing;
a first bus bar, a second bus bar and a third bus bar of the same shape, each of which has a pair of right and left contact spring pieces that are spaced in a given direction and parallel to each other, wherein the first bus bar, the second bus bar and the third bus bar are inserted into the housing and aligned in parallel in the given direction;
a first semiconductor light emitting element which is inserted into the housing, and connected to an adjacent pair of the right and left contact spring pieces of the first bus bar and the second bus bar;
a second semiconductor light emitting element which is inserted into the housing, and connected to an adjacent pair of the right and left contact spring pieces of the second bus bar and the third bus bar, wherein the second semiconductor light emitting elements emits light in a color temperature different from that of the first semiconductor light emitting element; and
a cover which accommodates the housing, and includes a lens through which outgoing lights from the first semiconductor light emitting element and the second semiconductor light emitting element pass.

2. The illuminating unit according to claim 1, wherein
each of the first bus bar, the second bus bar and the third bus bar has a pair of element abutting seats that are opposite to the respective right and left contact spring pieces, and
the first semiconductor light emitting element and the second semiconductor light emitting element have light emitting part defining surfaces, where light emitting parts are provided, which abut against the element abutting seats, to arrange the light emitting parts on a same plane.

3. The illuminating unit according to claim 1, further comprising
a control circuit that controls a light intensity of at least one of the first semiconductor light emitting element and the second semiconductor light emitting element to vary a color temperature of outgoing lights emitted through the lens.
